(19) United States
(12) Patent Application Publication
(10) Pub. No.: US 2004/0057051 A1
(43) Pub. Date: Mar. 25, 2004

(54) Surface reflectivity discriminating device

(75) Inventor: Vitaly Burkatovsky, Rishon LeZion (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Creo IL. Ltd.

(21) Appl. No.: 10/252,039

(22) Filed: Sep. 23, 2002

(51) Int. Cl. G01N 21/55

(52) U.S. Cl. 356/445

(57) ABSTRACT

Apparatus and method for discriminating between plate and interleave paper in a CTP device having a cassette with printing plates and interleave paper. The device uses a light source for illuminating the topmost object in the cassette, a first optical sensor for receiving direct light reflected from the topmost object, a second optical sensor for receiving dispersed light reflected from the topmost object, means for comparing light received by the second optical sensor with light received by the first optical sensor, and means for determining the topmost object type based on the comparison.

### FIELD OF THE INVENTION

The present invention relates to a discriminating device for discriminating between two kinds of objects based on surface reflectivity differences thereof, and more specifically to a device for discriminating between printing-plate and interleaf paper.

### BACKGROUND OF THE INVENTION

In CTP devices for direct imaging on printing plates, the plates are accommodated in a magazine, or cassette and provided one by one to be exposed by the imaging device.

The plates provided in the cassette are usually separated by interleaf paper, interposed between the plates, to prevent friction damages to the plates' emulsion-covered surfaces.

In the course of imaging plates, the plate placed at the top of the stack is picked and transferred to the exposure area for imaging. If an interleaf paper (slip-sheet) is placed at the top of the stack, the paper is picked and disposed of.

Accordingly, discriminating means for discriminating between plate and paper are used, to correctly identify the topmost object on the stack.

Published application EP 1136403 describes a discriminating device comprising two optical sensors. One of the sensors reacts to light reflected by both plate and paper, while the second sensor reacts only to light reflected by a plate. The first and the second sensors are placed on the optical axis of the light reflected from the sensed surface. Both sensors react to a predetermined intensity of reflected light. The difference is that the second sensor is inclined and its predetermined intensity is lower, in order to react to polymer surface only.

The disadvantage of the method of EP 1136403 lies in its low discrimination factor (‘paper’ to ‘metal’ signal ratio), which would require intensity (threshold) adjustments per batch of plates of the same type having different reflectivity, on top of intensity adjustment per plate-type.

There is need for a discriminating device that overcomes the shortcomings of existing devices. The required device should be independent of variations in material and of sub-variations within plates of the same material.

### SUMMARY OF THE INVENTION

The proposed surface discriminating method and device are free of the drawbacks of existing solutions, due to extended ratio of plate sensing to paper sensing signals, covering all differences between different materials and batches of the same material.

According to one aspect of the present invention, there is provided an apparatus for discriminating between objects having different surface reflectivity, comprising:

a light source for illuminating an object;

a first optical sensor mounted relative to said light source, said first optical sensor receiving direct light reflected from said object;

a second optical sensor mounted relative to said light source, said second optical sensor receiving dispersed light reflected from said object;

means for subtracting a light signal received by said second optical sensor from a light signal received by said first optical sensor, said means for subtracting connected with said first and second optical sensors; and

means for determining said object type, said means for determining connected with said means for subtracting.

The apparatus may additionally comprise a first amplifier connected with said first optical sensor and a second amplifier connected with said second optical sensor, wherein said first amplifier and said second amplifier are connected with said means for subtracting.

The means for determining may comprise a comparator and a reference, wherein said comparator compares an input thereof, received from said subtracting means, with said reference.

According to another aspect of the present invention, there is provided a CTP device for imaging printing plates stacked in a cassette, said plates separated by paper sheets, comprising:

an imaging system;

a first picking device for picking a topmost plate from said cassette and transporting said plate to said imaging system;

a second picking device for picking a topmost paper sheet from said cassette and transporting it to a disposal means; and

discriminating means for determining the type of a topmost object in said cassette, said discriminating means comprising:

a light source for illuminating said topmost object;

a first optical sensor mounted relative to said light source, said first optical sensor receiving direct light reflected from said topmost object;

a second optical sensor mounted relative to said light source, said second optical sensor receiving dispersed light reflected from said topmost object;

means for subtracting a light signal received by said second optical sensor from a light signal received by said first optical sensor, said means for subtracting connected with said first and second optical sensors; and

means for determining said topmost object type, said means for determining connected with said means for subtracting.

The apparatus may additionally comprise a first amplifier connected with said first optical sensor and a second amplifier connected with said second optical sensor, wherein said first amplifier and said second amplifier are connected with said means for subtracting.

The means for determining may comprise a comparator and a reference, wherein said comparator compares an input thereof, received from said subtracting means, with said reference.

The comparator's output is a logic high when said topmost object is a plate and a logic low when said topmost object is a paper sheet, or vice versa.

The first picking device and the second picking device may comprise a single picking device.

The first sensor and the second sensor may be mounted on a horizontal plane or on a sloped plane.

According to yet another aspect of the present invention, there is provided a method of discriminating between objects having different surface reflectivity, comprising the steps of:

providing a light source for illuminating an object;

providing a first optical sensor mounted relative to said light source, said first optical sensor receiving direct light reflected from said object;

providing a second optical sensor mounted relative to said light source, said second optical sensor receiving dispersed light reflected from said object;

subtracting a light signal received by said second optical sensor from a light signal received by said first optical sensor; and

determining said object type based on said step of subtracting.

According to yet another aspect of the present invention there is provided a method of determining the type of a topmost object in a plate loading cassette of a CTP device, comprising the steps of:

providing a light source for illuminating said topmost object;

providing a first optical sensor mounted relative to said light source, said first optical sensor receiving direct light reflected from said topmost object;

providing a second optical sensor mounted relative to said light source, said second optical sensor receiving dispersed light reflected from said topmost object;

subtracting a light signal received by said second optical sensor from a light signal received by said first optical sensor; and

determining said topmost object type based on said step of subtracting.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic representation of a discriminating device according to a first embodiment of the present invention;

FIG. 2 is a functional scheme of a discriminating device according to the present invention; and

FIG. 3 is a schematic representation of a discriminating device according to a second embodiment of the present invention.

### DETAILED DESCRIPTION OF THE PRESENT INVENTION

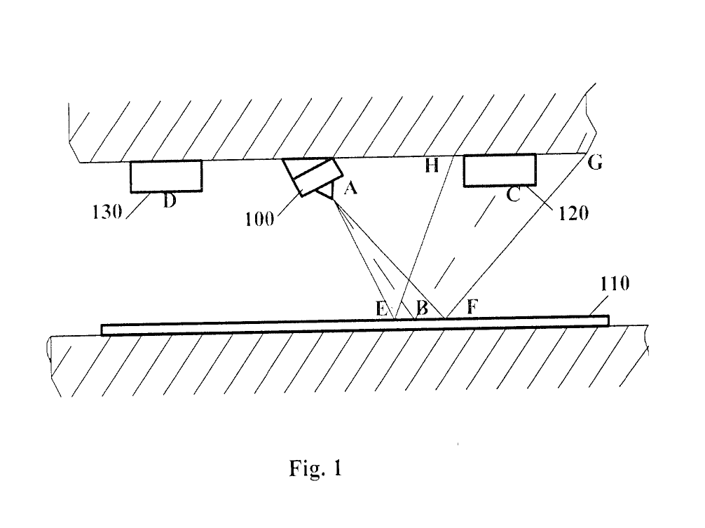

FIG. 1 is a schematic representation of a discriminating device according to the present invention, consisting of light source 100, for example light emitting diode (LED) such as SFH484, available from Siemens of Munich, Germany, two optical sensors 120 and 130, such as SFH-235, also available from Siemens of Munich, Germany and an object 110 to be detected, having a reflective surface.

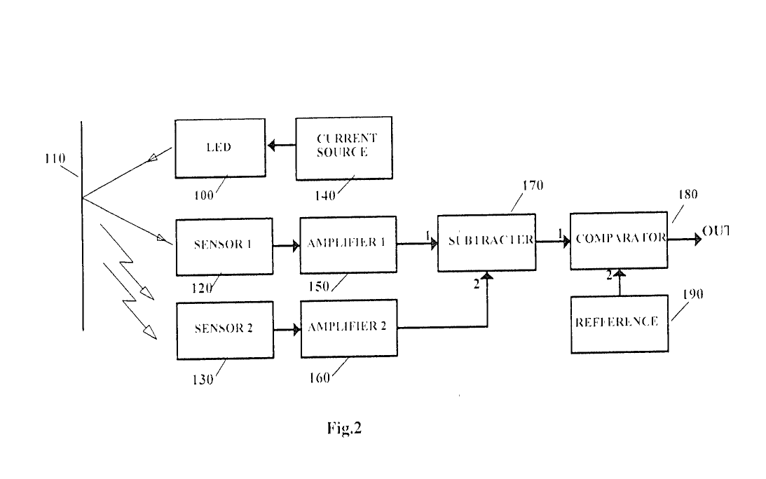

FIG. 2 is a more detailed functional scheme of a discriminating device according to the present invention. Light source 100 is energized by current source 140. A first sensor 120 is mounted so as to receive the direct reflection of the LED beam. Sensor 120 is connected through a first amplifier 150 to the input 1 of subtracter 170. The second sensor 130 is mounted outside of the optical axis of the reflective light, at some distance from sensor 120, preferably 2-4 cm, in order to detect the dispersed portion of the reflected light. Sensor 130 is connected through a second amplifier 160 to the input 2 of subtracter 170. The output of subtracter 170 is connected to the first input of comparator 180. The second input of the comparator 180 is connected to reference 190. In another preferred embodiment, an additional amplifier may be placed between subtracter 170 and comparator 180, to adjust the subtracter 170 output to the comparator 180 input. In yet another preferred embodiment of the present invention, subtracter 170 may be substituted with a divider or a multiplier (not shown).

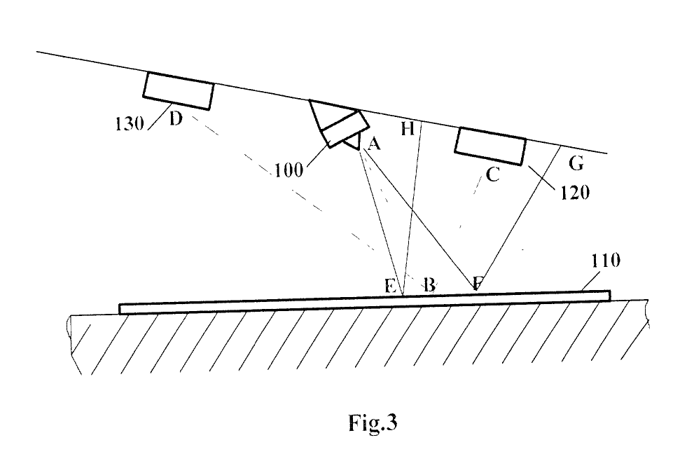

Referring back to FIG. 1, the distance between the sensors 120 and 130 is determined based on the following considerations: Sensor 120, intended to detect the directly reflected portion of the light, should be placed on the optical path of the directly reflected beam BC. The shorter the optical path ABC, the stronger will be the signal to noise ratio, which is desirable. Sensor 130, intended to detect the dispersed portion of the light, should be placed outside the area AEFGH of direct light reflection. It can be mounted, for example, on the other side of the light source 100, as shown in FIGS. 1 and 3, or on the same side, as shown in FIG. 2. The tradeoff in the placement considerations of sensor 130 is between decreasing the optical distance DB, from the sensor 130 to the direct beam reflecting point, which helps to increase the signal to noise ratio, and keeping the sensor 130 far enough from the light source so as not to fall within the direct light reflection area AEFGH and to be far enough from the investigated surface so that a big enough dispersed portion of light reaches it.

FIG. 3 is a schematic representation of another embodiment of the discriminating device of the present invention. The only difference between the embodiments of FIG. 1 and FIG. 3 is in the layout of the light source 100 and the sensors 120 and 130. In the embodiment of FIG. 3 those elements are laid out on a sloped surface, so that the vertical distance of sensor 120 from the detected surface is smaller comparing to that shown in FIG. 1, so the sensor signal will be stronger. On the other hand, the vertical distance of sensor 130 from the detected surface is big enough to receive enough dispersed light.

The device operates as follows:

After power up, constant current from the current source 140 causes the lighting of LED 100. This light falls onto detected surface 110. If the detected surface 110 is smooth, like a plate, then the directly reflected portion Ds of the light will be big and the dispersed portion Ss will be small. If the detected surface is rough, like paper, then the directly reflected portion Dr of the light will be smaller than Ds and the dispersed portion Sr will be bigger than Ss.

The first and second sensors' signals are amplified by first amplifier 150 and second amplifier 160, respectively.

The output signal of the second amplifier 160 is subtracted from the output signal of the first amplifier 150 in subtracter 170. When a plate is detected, the result of the subtraction (DsSs) yields a high value (because, as mentioned above, a low signal is subtracted from a high signal). When paper is detected, the result of the subtraction (Dr-Sr) yields a low value (because, as mentioned above, a high signal is subtracted from low signal).

In other words, when detecting plate, the result of the subtraction yields a high level signal and, when detecting paper, the result of the subtraction yields a low level signal. Comparator 180 compares the subtraction result with medium level reference 190. If the detected surface is a plate, then the comparison will result with a logic high and if the detected surface is paper, then the comparison will result with a logic low, or vice versa if reverse logic is used.

In a preferred embodiment of the present invention, the amplifiers 150 and 160 have different amplification coefficients, chosen so as to maximize the difference between subtracter 170 outputs for plate and paper, thus increasing the discrimination factor.

Let Vsns1 and Vsns2 be the outputs voltage of direct (120) and dispersed (130) light sensors respectively.

Let A1 and A2 be the amplification factors of first (150) and second (160) amplifiers respectively.

Let U1 and U2 be the output voltage of first (150) and second (160) amplifiers respectively, where:

U1=A1*Vsns1

U2=A2*Vsns2

When a plate is sensed:

U1(pl)=A1*Vsns1(pl)

U2(pl)=A2*Vsns2(pl)1

The output of subtracter 170 will be:

IND(pl)=U1(pl)−U2(pl)

When paper is sensed:

U1(pa)=A1*Vsns1(pa)

U2(pa)A2*Vsns2(pa)

The output of subtracter 170 will be:

IND(pa)=U1(pa)−U2(pa)

A1 and A2 will preferably be chosen so as to maximize the ratio IND(pl):IND(pa).

It will be appreciated that although the embodiments of the present invention were described in conjunction with a plate loading system for CTP, the present invention lends itself to any discriminating device for discriminating between two kinds of objects based on surface reflectivity differences thereof.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

What is claimed is:

1. Apparatus for discriminating between objects having different surface reflectivity, comprising:
a light source for illuminating an object;
a first optical sensor mounted relative to said light source, said first optical sensor receiving direct light reflected from said object;
a second optical sensor mounted relative to said light source, said second optical sensor receiving dispersed light reflected from said object;
computation means for comparing a light signal received by said second optical sensor with a light signal received by said first optical sensor, said computation means connected with said first and second optical sensors; and
means for determining said object type, said means for determining connected with said computation means.

2. The apparatus of claim 1, wherein said computation means comprises means for subtracting.

3. The apparatus of claim 1, additionally comprising a first amplifier connected with said first optical sensor and a second amplifier connected with said second optical sensor, wherein said first amplifier and said second amplifier are connected with said computation means.

4. The apparatus of claim 1, wherein said means for determining comprises a comparator; and additionally comprising a reference, wherein said comparator compares an input thereof, received from said computation means, with said reference.

5. The apparatus of claim 3, additionally comprising a third amplifier connected with said computation means and with said means for determining.

6. A CTP device for imaging printing plates stacked in a cassette, said plates separated by paper sheets, comprising:
an imaging system;
a first picking device for picking a topmost plate from said cassette and transporting said plate to said imaging system;
a second picking device for picking a topmost paper sheet from said cassette and transporting it to a disposal means; and
discriminating means for determining the type of a topmost object in said cassette, said discriminating means comprising:
a light source for illuminating said topmost object;
a first optical sensor mounted relative to said light source, said first optical sensor receiving direct light reflected from said topmost object;
a second optical sensor mounted relative to said light source, said second optical sensor receiving dispersed light reflected from said topmost object;
computation means for comparing a light signal received by said second optical sensor with a light signal received by said first optical sensor, said computation means connected with said first and second optical sensors; and
means for determining said topmost object type, said means for determining connected with said computation means.

7. The apparatus of claim 6, wherein said computation means comprises means for subtracting.

8. The apparatus of claim 6, additionally comprising a first amplifier connected with said first optical sensor and a second amplifier connected with said second optical sensor, wherein said first amplifier and said second amplifier are connected with said computation means.

9. The apparatus of claim 6, wherein said means for determining comprises a comparator; and additionally comprising a reference, wherein said comparator compares an input thereof, received from said computation means, with said reference.

10. The apparatus of claim 9, wherein said comparator's output is a logic high when said topmost object is a plate and a logic low when said topmost object is a paper sheet.

11. The apparatus of claim 9, wherein said comparator's output is a logic low when said topmost object is a plate and a logic high when said topmost object is a paper sheet.

12. The apparatus of claim 6, wherein said first picking device and said second picking device comprise a single picking device.

13. The apparatus of either of claims 1 and 6, wherein said first sensor and said second sensor are mounted on a horizontal plane.

14. The apparatus of either of claims 1 and 6, wherein said first sensor and said second sensor are mounted on a sloped plane.

15. A method of discriminating between objects having different surface reflectivity, comprising the steps of:
providing a light source for illuminating an object;
providing first optical sensor mounted relative to said light source, said first optical sensor receiving direct light reflected from said object;
providing a second optical sensor mounted relative to said light source, said second optical sensor receiving dispersed light reflected from said object;
comparing a light signal received by said second optical sensor with a light signal received by said first optical sensor; and
determining said object type based on said step of comparing.

16. The method of claim 15, wherein said step of comparing comprises subtracting.

17. In a CTP device, a method of determining the type of a topmost object in a plate loading cassette, comprising, the steps of:
providing a light source for illuminating said topmost object;
providing a first optical sensor mounted relative to said light source, said first optical sensor receiving direct light reflected from said topmost object;
providing a second optical sensor mounted relative to said light source, said second optical sensor receiving dispersed light reflected from said topmost object;
comparing a light signal received by said second optical sensor with a light signal received by said first optical sensor; and
determining said topmost object type based on said step of comparing.

18. The method of claim 17, wherein said step of comparing comprises subtracting.
